(19) United States
(12) Patent Application Publication
(10) Pub. No.: US 2013/0211965 A1
(43) Pub. Date: Aug. 15, 2013

(54) SYSTEMS AND METHODS FOR ACQUIRING AND GENERATING COMPARISON INFORMATION FOR ALL COURSE BOOKS, IN MULTI-COURSE STUDENT SCHEDULES

(71) Applicants: Jonathan Simkin, Del Mar, CA (US); Benjamin Carson, West Hollywood, CA (US); Kevin King, Poway, CA (US); Daniel Halloran, San Francisco, CA (US)

(72) Inventors: Jonathan Simkin, Del Mar, CA (US); Benjamin Carson, West Hollywood, CA (US); Kevin King, Poway, CA (US); Daniel Halloran, San Francisco, CA (US)

(73) Assignee: RAFTER, INC, San Mateo, CA (US)

(21) Appl. No.: 13/570,126

(22) Filed: Aug. 8, 2012

Related U.S. Application Data
(60) Provisional application No. 61/521,703, filed on Aug. 9, 2011.

(51) Int. Cl. G06Q 30/06

(52) U.S. Cl. CPC G06Q 30/0629
USPC 705/26.64

(57) ABSTRACT

Provided are systems, methods and computer programs for generating comparison information for all course books, regardless of whether or not the books are required or optional, for multi-course student schedules. Also provided are systems, methods and computer programs for transacting sales between sellers and buyers of course books and online products, wherein the sellers and buyers may be online or offline and the online products may have a standardized product identification number.

### RELATED APPLICATION

This patent application claims priority under 35 U.S.C. §119(e) of the co-pending, co-owned U.S. Provisional Patent Application No. 61/521,703, filed Aug. 9, 2011, titled, “SYSTEMS AND METHODS FOR ACQUIRING AND GENERATING COMPARISON INFORMATION FOR ALL COURSE BOOKS, IN MULTI-COURSE STUDENT SCHEDULES, AND FOR TRANSACTING SALES BETWEEN SELLERS AND BUYERS OF COURSE BOOKS AND ONLINE PRODUCTS,” which is hereby incorporated by reference in its entirety.

### FIELD OF THE INVENTION

The present disclosure relates to systems and methods for purchasing books or other products, in particular, systems and methods for acquiring and generating comparison information for all course books, regardless of whether or not the books are required or optional, for multi-course student schedules.

The present disclosure also relates to, in particular, systems and methods for transacting sales between sellers and buyers of course books and online products, wherein the sellers and buyers may be online or offline, and the online products may have a standardized product identification number.

### BACKGROUND OF THE INVENTION

Parents and students of all ages face two distinct challenges when purchasing required books for school. First, they must determine which books are needed for the courses in which they are enrolled, whether or not those books are required or optional (the “Course Books”). This is most commonly achieved through the use of on-site bookstore web sites. These web sites contain data from one school only, and through inputting academic departments, courses within that department, and specific course sections, a student attending that school is able to determine which Course Books to purchase upon enrollment.

The second challenge faced by students entails optimizing Course Book selection online, given the student's individual Course Book selection criteria.

Students seeking to compare their Course Books must either locate those Course Books manually and then compare them online manually, or input one course at a time into a search function that outputs Course Books and vendors that sell those Course Books. While the latter method is more efficient than the former, both methods cost students substantially in terms of time and convenience.

Parents and students of all ages face several challenges when selling Course Books to potential online Course Book purchasers (the “Course Book Buyers”). First, student and parent sellers of Course Books (the “Course Book Sellers”) must track down price offerings for each of the Course Books they seek to sell. The easiest way to do this is online, either through typing Course Book International Standard Book Numbers (“ISBNs”) into organic search engines or through typing Course Book ISBNs into an online book price aggregator. These aggregators show a list of Course Book Buyer price offerings for selected Course Books and link Course Book Sellers to Course Book Buyer web sites for direct purchase of those Course Books. The aggregator does not finalize a Course Book sale: the Course Book Seller completes this task directly through the Course Book Buyer's web site.

Another challenge faced by Course Book Sellers entails organizing the Course Books for shipment to selected Course Book Buyers. Since different Course Book Buyers offer different Course Book prices, Course Book Sellers, in order to maximize Course Book sales revenue, frequently must sell their Course Books to multiple Course Book Buyers rather than to a single Course Book Buyer. Course Book Sellers dealing with multiple Course Book Buyers must organize their Course Books for the appropriate Course Book Buyers and must include Course Book Buyer-specific paperwork (shipping receipts and packing slips) with each Course Book shipment. This process is able to take Course Book Sellers from several hours to several days to complete.

Course Book Sellers are then faced with a dilemma. They are able to sell all their Course Books to a single Course Book Buyer and avoid the extra time spent sorting through multi-Course Book Buyer shipments, but then they are not able to take advantage of multiple price offerings to maximize Course Book sales revenue. Alternatively, if they use a price aggregator and find the best prices from multiple Course Book Buyers, they must spend hours to days completing the Course Book Buyback Process.

The dilemma poses a particularly difficult challenge for K-12, college, and graduate student Course Book Sellers seeking to sell their Course Books on an educational institution's premises or in the nearby vicinity of those premises (the “Student Course Book Sellers”). Student Course Book Sellers frequently lack the time, desire, and skills to complete the Course Book Buyback Process. Furthermore, neither book price aggregators nor other existing web-based solutions provide Student Course Book Sellers with the tools they need to sell their Course Books on an educational institution's premises or in the nearby vicinity of those premises.

Parents and students of all ages face several challenges when selling general products of any kind (the “Products”) to potential online Product purchasers (the “Buyers”). First, student and parent sellers of Products (the “Sellers”) must track down price offerings for each of the Products they seek to sell. The easiest way to do this is online, either through typing the Product's name, or if available, any standardized means of identifying the Product (the “Identifier”), including the Product's Identification Number (the “Number”), into organic search engines or through typing the Product's Identifier into an online price aggregator. These aggregators show a list of Buyer price offerings for selected Products and link Sellers to Buyer web sites for direct purchase of those Products. The aggregator does not finalize a Product sale: the Seller completes this task directly through the Buyer's web site.

Another challenge faced by Sellers entails organizing the Products for shipment to selected Buyers. Since different Buyers offer different Product prices, Sellers, in order to maximize Product sales revenue, frequently must sell their Products to multiple Buyers rather than to a single Buyer. Sellers dealing with multiple Buyers must organize their Products for the appropriate Buyers and must include Buyer-specific paperwork (shipping receipts and packing slips) with each Product shipment. This process is able to take Sellers from several hours to several days to complete. Existing book price aggregators provide no means of automating the multi-Buyer Product organization process (the “Process”).

Sellers are then faced with a dilemma. They are able to sell all their Products to a single Buyer and avoid the extra time spent sorting through multi-Buyer Product shipments, but then they are not able to take advantage of multiple price offerings to maximize Product sales revenue. Alternatively, if they use a price aggregator and find the best prices from multiple Buyers, they must spend hours to days completing the Process. No existing book price aggregator gives Sellers the tools to maximize Product sales revenue and simultaneously avoid the high time costs associated with completing the Process.

The dilemma poses a particularly difficult challenge for K-12, college, and graduate student Sellers seeking to sell their Products on an educational institution's premises or in the nearby vicinity of those premises (the “Student Sellers”). Student Sellers frequently lack the time, desire, and skills to complete the Process. Furthermore, neither Product price aggregators nor other existing web-based solutions provide Student Sellers with the tools they need to sell their Products on an educational institution's premises or in the nearby vicinity of those premises.

### SUMMARY OF THE INVENTION

Systems, methods and computer programs for acquiring and generating comparison information for all course books, regardless of whether or not the books are required or optional, for multi-course student schedules.

Also, systems, methods and computer programs for transacting sales between sellers and buyers of course books and online products, wherein the sellers and buyers may be online or offline and the online products may have a standardized product identification number.

In one aspect, a method of generating price comparison information for books for multi-course student schedules programmed in a memory of a device, comprises acquiring schedule components information, generating intermediate outputs using the schedule components and generating final outputs using the intermediate outputs. Acquiring the schedule components information is by schools submitting the schedule components information, and/or acquiring the schedule components information is by a web-crawler. The web-crawler generates queues that determine from which school and education-related websites to acquire the schedule components information. The queues are distributed over a plurality of servers and external hardware devices. The web-crawler assembles an organized database of schedule components information. The intermediate outputs comprise course book information. The course book information comprises images of course books. The final outputs comprise pricing information and vendor information. The schedule components information includes departments, course names and course sections. The final outputs include bundled selections of course materials and price comparisons of the bundled selections. The bundled selections are from a single merchant Alternatively, the bundled selections include bundles from a plurality of merchants The final outputs are filtered using user selections.

In another aspect, a method of generating price comparison information for books for multi-course student schedules programmed in a memory of a device comprises acquiring schedule components information, acquiring an input from a user, generating intermediate outputs using the schedule components and generating final outputs using the intermediate outputs. The input includes a plurality of course selections. The input includes a department and a course. The input includes a school, an academic department, a course and/or a course section. Acquiring the schedule components information is by schools submitting the schedule components information, and/or acquiring the schedule components information is by a web-crawler. The web-crawler generates queues that determine from which school and education-related websites to acquire the schedule components information. The queues are distributed over a plurality of servers and external hardware devices. The web-crawler assembles an organized database of schedule components information. The intermediate outputs comprise course book information. The course book information comprises images of course books. The final outputs comprise pricing information and vendor information. The schedule components information includes departments, course names and course sections. The final outputs include bundled selections of course materials and price comparisons of the bundled selections. The bundled selections are from a single merchant. Alternatively, the bundled selections include bundles from a plurality of merchants. The final outputs are filtered using user selections.

In another aspect, a device comprises a memory for storing an application, the application programmed to perform the steps: acquiring schedule components information, generating intermediate outputs including course book information using the schedule components and generating final outputs including bundled selections of course materials and price comparisons of the bundled selections using the intermediate outputs and a processor for processing the application. Acquiring the schedule components information is by schools submitting the schedule components information, and/or acquiring the schedule components information is by a web-crawler. The web-crawler generates queues that determine from which school and education-related websites to acquire the schedule components information. The queues are distributed over a plurality of servers and external hardware devices. The web-crawler assembles an organized database of schedule components information. The course book information comprises images of course books. The final outputs comprise pricing information and vendor information. The schedule components information includes departments, course names and course sections. The bundled selections are from a single merchant. Alternatively, the bundled selections include bundles from a plurality of merchants. The final outputs are filtered using user selections.

In another aspect, a method of generating price comparison information for books for multi-course student schedules programmed in a plurality of cloud devices comprises acquiring schedule components information, generating intermediate outputs using the schedule components and generating final outputs using the intermediate outputs, wherein the final outputs include bundled selections of course materials and price comparisons of the bundled selections. Acquiring the schedule components information is by schools submitting the schedule components information and/or acquiring the schedule components information is by a web-crawler. The web-crawler generates queues that determine from which school and education-related websites to acquire the schedule components information. The queues are distributed over a plurality of servers and external hardware devices. The web-crawler assembles an organized database of schedule components information. The intermediate outputs comprise course book information. The course book information comprises images of course books. The final outputs comprise pricing information and vendor information. The schedule components information includes departments, course names and course sections. The bundled selections are from a single merchant. Alternatively, the bundled selections include bundles from a plurality of merchants. The final outputs are filtered using user selections.

In another aspect, a device for receiving price comparison information for books for multi-course student schedules comprises a memory for storing an application, the application programmed to perform the steps sending schedule information to a cloud system and receiving final outputs including bundled selections of course materials and price comparisons of the bundled selections generated in the cloud system using intermediate outputs generated using the schedule information and a processor for processing the application.

### BRIEF DESCRIPTION OF THE DRAWINGS

The embodiments are illustrated by way of example and not limitation in the figures of the accompanying drawings in which like references indicate like elements.

FIG. 1 illustrates a diagram of a process of price comparison, in accordance with an embodiment of the present disclosure.

FIG. 2 illustrates another diagram of a process of price comparison, in accordance with an embodiment of the present disclosure.

FIG. 3A illustrates a diagram of a structure used for price comparison, in accordance with an embodiment of the present disclosure.

FIG. 3B illustrates a screenshot of the price comparison system in accordance with an embodiment of the present disclosure.

FIG. 4A illustrates a diagram of another structure used for price comparison, in accordance with an embodiment of the present disclosure.

FIG. 4B illustrates another screenshot of the price comparison system in accordance with an embodiment of the present disclosure.

FIG. 5A illustrates a diagram of another structure used for price comparison, in accordance with an embodiment of the present disclosure.

FIG. 5B illustrates another screenshot of the price comparison system in accordance with an embodiment of the present disclosure.

FIG. 6 illustrates a diagram of another structure used for price comparison, in accordance with an embodiment of the present disclosure.

FIG. 7 illustrates a diagram of components used by the transactions methods, in accordance with an embodiment of the present disclosure.

FIG. 8 illustrates another diagram of components used by the transactions methods, in accordance with an embodiment of the present disclosure.

FIG. 9 illustrates a diagram of interactions in accordance with an embodiment of the present disclosure.

FIG. 10 illustrates a diagram of component interactions in accordance with an embodiment of the present disclosure.

FIG. 11 illustrates another diagram of interactions in accordance with an embodiment of the present disclosure.

FIG. 12 illustrates another diagram of component interactions in accordance with an embodiment of the present disclosure.

FIG. 13 illustrates another diagram of interactions in accordance with an embodiment of the present disclosure.

FIG. 14 illustrates another diagram of component interactions in accordance with an embodiment of the present disclosure.

FIG. 15 illustrates a diagram of components used by the present disclosure, in accordance with an embodiment of the present disclosure.

FIG. 16 illustrates another diagram of components used by the present disclosure, in accordance with an embodiment of the present disclosure.

FIG. 17 illustrates a diagram of interactions in accordance with an embodiment of the present disclosure.

FIG. 18 illustrates a diagram of component interactions in accordance with an embodiment of the present disclosure.

FIG. 19 illustrates another diagram of interactions in accordance with an embodiment of the present disclosure.

FIG. 20 illustrates another diagram of component interactions in accordance with an embodiment of the present disclosure.

FIG. 21 illustrates diagram of a computing device in accordance with an embodiment of the present disclosure.

FIG. 22 illustrates a diagram of a network of devices utilizing cloud computing in accordance with an embodiment of the present disclosure.

### DETAILED DESCRIPTION OF THE PREFERRED EMBODIMENT

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment, and such references mean at least one.

The use of headings herein is merely provided for ease of reference and shall not be interpreted in any way to limit this disclosure or the following claims.

Reference in this specification to “one embodiment” or “an embodiment” or the like means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

### Price Comparison for Course Books in a Multi-Course Schedule

This present disclosure comprises a method, which may be implemented using any comparative programming language that may be compilable onto a hardware platform, and an accompanying web-crawler application (the “Web-Crawler Application”) or another application for receiving input in the form of a student class schedule, including a combination of: a school, one or more academic departments, department courses, course sections, and potentially other class schedule items (the “Schedule Components”). The present disclosure then generates a final output including vendors that supply the class schedule's Course Books and any Criteria combination applicable to those Course Books that the person using the present disclosure (the “User”) selects for display in the final output. Final outputs need not include the “price” Criterion referred to in the Figures; they may include any combination of Criteria, with or without the price Criterion, that the User selects for display, or any individual Criterion, which may or may not be the price Criterion, that the User selects for display. The Criteria may include, but are not limited to, purchase price, rental price, rental availability, Course Book quality criteria, digital book price, digital book availability, e-book price, e-book availability, shipping criteria, and convenience criteria. The present disclosure applies specifically to an inputted schedule including multiple courses, and the subsequent use of that inputted schedule to generate a final output. Inputs need not entail all four Schedule Components referred to in the Figures; they may include any combination therein so long as multiple courses are used as inputs for generating the final output.

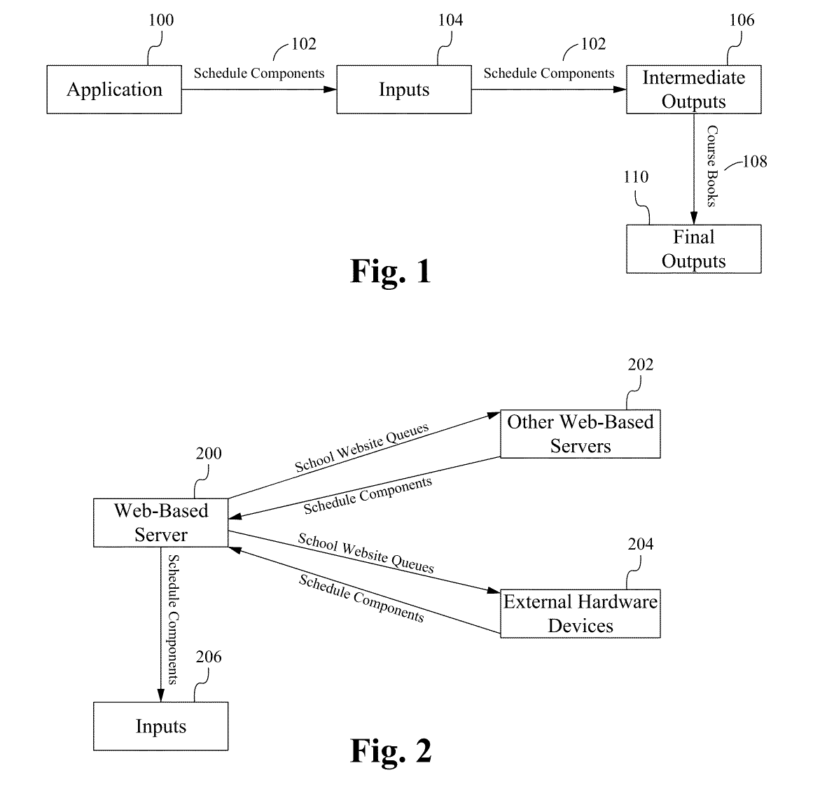

A more detailed outline of the price comparison system and method is illustrated by the diagram in FIG. 1. The price comparison system acquires Schedule Components 102 through the use of its Web-Crawler Application 100 or another implementation, the price comparison system uses the Schedule Components 102 as inputs 104 to generate intermediate outputs 106 in the form of Course Books 108, and the present disclosure uses those intermediary outputs 106 as inputs for generating final outputs 110. The last three steps (inputs, intermediate outputs and final outputs) are implemented by any imperative programming language that is able to be compiled onto a hardware platform. The price comparison system as a whole runs on any hardware device.

FIG. 2 diagrams the price comparison system's Web-Crawler Application, which acquires and organizes raw Schedule Component data. The Application, operating via any type of web-based server 200, begins by generating queues that determine from which school and education-related websites the Web-Crawler Application will acquire Schedule Component data and in what order. The various queues are distributed to other web-based servers 202, which are able to be of any type, or external hardware devices 204, which also are able to be of any type. Via these other web-based servers 202 and external hardware devices 204, the Web-Crawler Application completes the tasks on the various queues, acquiring raw Schedule Component data from various school and education-related websites. Using this raw data, the Web-Crawler Application assembles a complete and organized database of Schedule Components, from which inputs 206 for the next step in the present disclosure are able to be selected. The present disclosure's Web-Crawler Application is implemented using any type of imperative programming language that is able to be compiled onto a hardware platform. In some embodiments, Schedule Component data is gathered and organized by another implementation such as by being submitted or input by sources of the data.

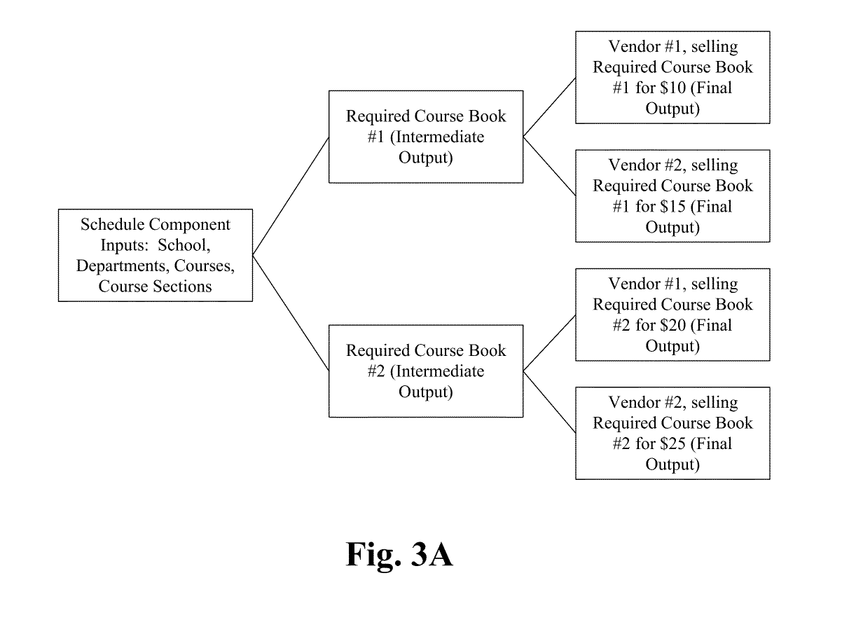

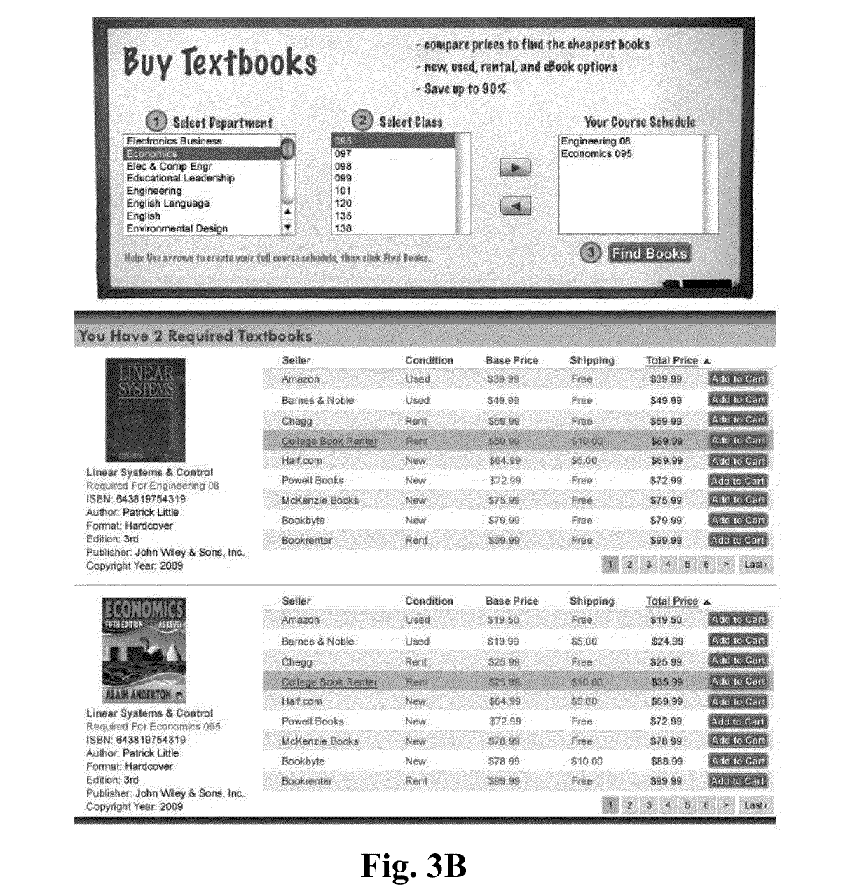

A set of Schedule Components, acquired from the information diagramed in FIG. 2, generates one or more intermediate outputs, and each intermediate output generates one or more final outputs. The example in FIG. 3A illustrates this idea. FIG. 3A's set of Schedule Components requires the purchase of two Course Books, and both Course Books are able to be purchased, with differing Criteria applying, from Vendor #1 and from Vendor #2. The number of data points in this example is mostly arbitrary, as the price comparison system is able to process an unlimited number of intermediate and final outputs. However, the price comparison system contains a set of Schedule Component inputs with multiple courses, as the plural designations in FIG. 3A indicate. In FIG. 3A, individual vendors may sell a Course Book across a range of prices, and each of those prices is considered part of the price comparison system's final output. For simplification purposes, the embodiment described in FIG. 3A has only one price per Course Book vendor. FIG. 3A also refers to four Schedule Components, but the price comparison system only requires sufficient Schedule Components so as to acquire a set of inputs including two or more course sections. Furthermore, FIG. 3A contains the price Criterion as the sole Criterion included within the final output, but the price comparison system may include any combination of Criteria, or any individual Criterion, as selected for display by the User, in the final output.

FIG. 3B illustrates one example of how the price comparison system may be displayed for students and other members of the public: via an online web application. FIG. 3B shows an example of applicable, inputted Schedule Components in two, labeled, pull-down menus and displays a list of courses for review by the web application's User in a box to the right of the Schedule Components (courses are designated as “classes” in this particular web application). Below these menus are images of Course Books corresponding to the inputted Schedule Components. These Course Books function as intermediate outputs and serve as inputs for generating the final output in FIG. 3B: a list of vendors that sell the Course Books and the prices at which they sell those Course Books. In FIG. 3B, final outputs are displayed in tables adjacent to the images of the intermediate outputs, namely the Course Books. This web application does not represent the exclusive means of displaying the present disclosure for the public. In FIG. 3B, department and class (course) are the only Schedule Components used as inputs in this web application, but actual inputs may be a combination of: a school, one or more academic departments, department courses, course sections, and potentially other Schedule Components. Furthermore, the intermediate outputs are represented by pictures in the leftmost column in the web application and the final outputs are listed within “Vendor” and “Total Price” columns. FIG. 3B contains the price Criterion as the sole Criterion included within the final output, but the price comparison system may include any combination of Criteria, or any individual Criterion, as selected for display by the User, in the final output.

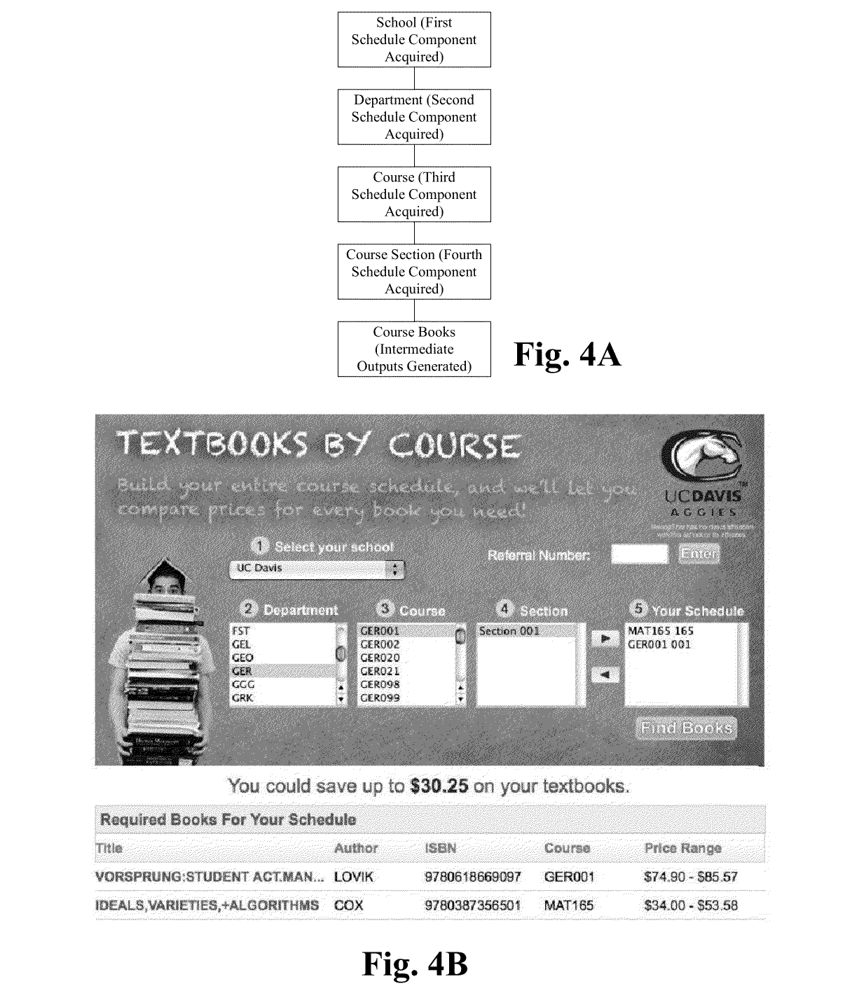

As demonstrated in FIG. 4A, the present disclosure's intermediate output generation process begins when the present disclosure collects Schedule Component inputs. In the embodiment of the present disclosure described in this figure, all four Schedule Components are used as input types, but other embodiments may require fewer input types, so long as the present disclosure acquires a set of inputs including two or more courses. In the embodiment displayed in FIG. 4A, the first of the Schedule Components is the school, which designates the subsequent set of Schedule Components that the price comparison system will use. Each school is affiliated with its own set of Schedule Components, from which the price comparison system acquires all additional input types, including departments, course names, and sections, or any combination thereof. The price comparison system then uses the acquired Schedule Components to generate intermediate outputs in the form of Course Books. The price comparison system is able to repeat the intermediate output generation process multiple times to generate several intermediate outputs for any given school. FIG. 4A refers to four Schedule Components, but the price comparison system only requires sufficient Schedule Components so as to acquire a set of inputs including two or more course sections.

FIG. 4B illustrates an example of the intermediate output generation process as displayed through an online web application. The four pull-down menus prompt Users to select applicable Schedule Components as inputs. Users may repeat inputting the Schedule Components as many times as necessary, for any given school, and the resulting class schedules are generated for display in the box to the right of the pull-down menus. Clicking the “FindBooks” button will generate intermediate outputs in a vertical list below the pull-down menus. This web application does not represent the exclusive means of displaying the present disclosure's intermediate output generation process. In FIG. 4B, the following elements: (1) Select your school, (2) Department, (3) Course, and (4) Section comprise Schedule Component Inputs. The component (5) Your Schedule is the compilation of course sections for which the present disclosure will generate intermediate outputs. Also, “Required Books for Your Schedule” introduces the list of intermediate outputs in the form of Course Books. The Course Book titles are in the leftmost column. Two intermediate outputs have been generated in FIG. 4A.

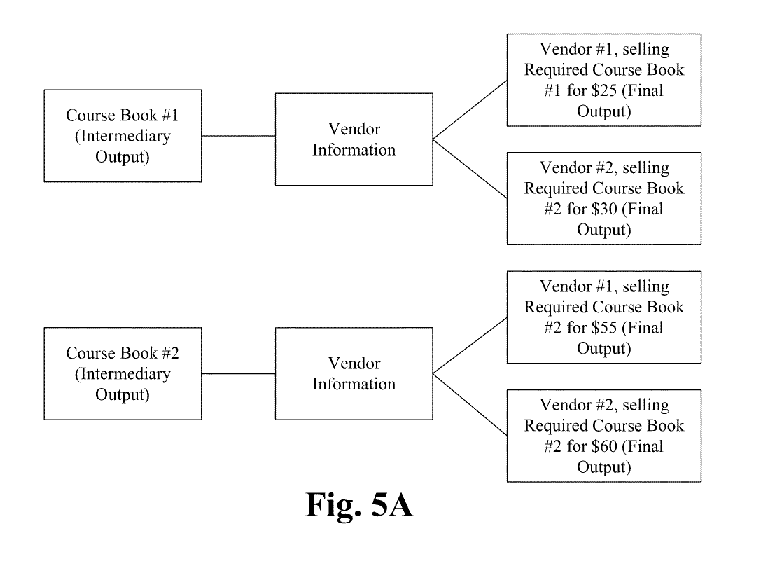

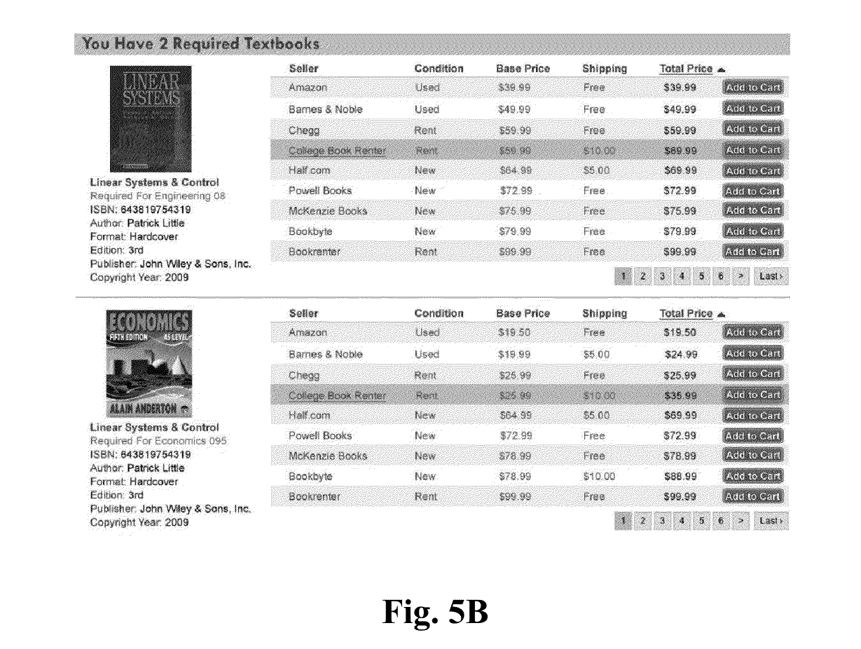

The intermediate output data, the list of Course Books for a set of Schedule Components, serve as inputs for the price comparison system's final outputs: Course Book vendors and the Criteria combination, selected by the User, that the vendors apply to the Course Books. Each intermediate output is linked to information about Course Book vendors and corresponding Course Book Criteria, which constitutes the final output. Multiple final outputs containing vendor and Criteria information may be linked to each intermediate output. The price comparison system's intermediate to final output generation process is illustrated by FIG. 5A. FIG. 5A contains the price Criterion as the sole Criterion included within the final output, but the price comparison system may include any combination of Criteria, or any individual Criterion, as selected for display by the User, in the final output. FIG. 5A refers to four Schedule Components, but the price comparison system only requires sufficient Schedule Components so as to acquire a set of inputs including two or more course sections.

FIG. 5B shows an illustration of the intermediate to final output generation process as displayed through a web application. The web application displays final output data as text adjacent to images of two intermediate outputs, meaning Course Book vendors and corresponding Criteria combinations are displayed adjacent to each Course Book to which they are applicable. This web application is not the exclusive means of displaying the price comparison system's intermediate to final output generation process. The two Course Books, displayed as images on the left side of the Figure, represent the Invention's intermediate outputs. The columns entitled “Vendor” and “Total Price” contain lists of final outputs. The left-most indented column beneath each intermediate output lists the names of vendors selling the Course Book, and an indented column farther to the right shows the price(s) at which each vendor is selling the Course Book. In FIG. 5B, the vendors and their corresponding prices constitute the Invention's final outputs. However, the price comparison system may include any combination of Criteria, or any individual Criterion, as selected for display by the User, in the final output. There are a total of eighteen final outputs in this example, nine, corresponding to the first intermediate output and nine corresponding to the second intermediate output.

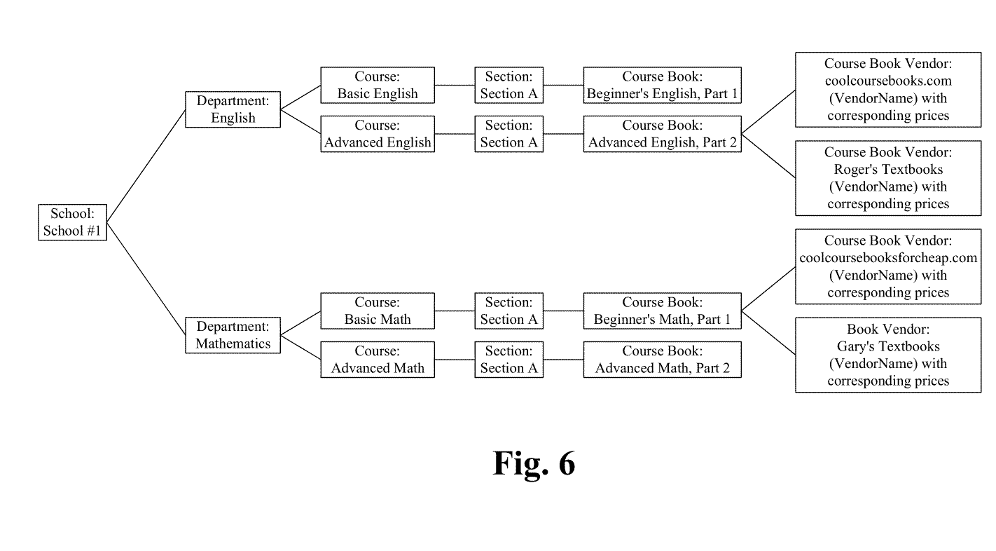

FIG. 6 summarizes the interactions through which the price comparison system functions. FIG. 6 does so through listing an exemplary school and all Schedule Components, intermediate outputs, and final outputs corresponding to that school. The embodiment of the price comparison system displayed in FIG. 6 uses four Schedule Components as inputs. For the first Schedule Component, a school is listed: School #1. School #1 has two departments for the second Schedule Component: English and Mathematics. Each department has two courses for the third Schedule Component: English has Basic English and Advanced English, while Mathematics has Basic Math and Advanced Math. Each course, in turn, has two course sections, which constitute the fourth Schedule Component. There are eight sections in total: Basic English sections A and B, Advanced English sections A and B, Basic Math sections A and B, and Advanced Math sections A and B. Each course section requires one Course Book, yielding a total of eight intermediate outputs. However, for simplification purposes, FIG. 6 only displays two intermediate outputs: Advanced English, Part 2, and Beginner's Math, Part 1. Each of these intermediate outputs corresponds to one or more final outputs. The simplified final output includes four vendors, two for the English Course Book and two for the Math Course Book: coolcoursebooks.com, Roger's Textbooks, coursebooksforcheap.com, and Gary's Course Books. Also contained within these simplified final outputs are the prices at which each of the vendors sell the Course Books. The parts of the price comparison system illustrated by FIG. 6 are implemented, using any imperative programming language that is able to be compiled onto a hardware platform. FIG. 6 refers to four Schedule Components, but the present disclosure only requires sufficient Schedule Components so as to acquire a set of inputs including two or more course sections. Furthermore, FIG. 6 includes only the price Criterion in the final output, but the price comparison system may include any combination of Criteria, or any individual Criterion, as selected for display by the User, in the final output.

In some embodiments, the final outputs include bundled selections of course materials and price comparisons of the bundled selections. For example, after determining the user needs 10 specific course books for his classes, instead of or in addition to displaying the 10 specific course books separately with their respective individual prices, the 10 course books are bundled. A single bundle price is compared with other bundled prices and the bundled price comparison is displayed. The bundled price is able to be books bundled by a single seller or multiple sellers. For example, the price comparison is for bundled prices from specific merchants only (e.g., the bundle price at Amazon.com versus the bundle price at Half.com versus the bundle price at Barnes&Noble). In another example, the price comparison is bundled prices from various merchants Furthering the example, if a student needs 10 books, one bundle price might include 2 books from Amazon.com, 3 from Half.com and 5 from university bookstore. Another bundle price might be the cheapest combination of sellers with 4 star ratings or higher with shipping less than 7 days (4 books from Amazon.com, 1 from Half.com and 5 from the university bookstore). The price comparison results are able to be filtered using any implementation. For example, the price comparison results are able to be filtered by user preferences of the seller rating, book condition, estimated shipping time, and/or any other filter option. The filters are able to be used on an individual book level or on a book list using the bundle option.

The price comparison system's underlying software operates across a variety of external hardware devices. The price comparison system operates across any external hardware device. The price comparison system is able to operate with an Android™ system, an Apple® system, a Windows® system and/or any other system. The price comparison system is able to operate on a personal computer, a smart phone or any other device. The embodiments described herein are possible, but not exclusive, manifestations of the price comparison system operating on external hardware devices.

### Transacting Sales Between Buyers and Sellers of Course Books and Online Products

The present disclosure encompasses a method (the “Course Book Buyback Method”) and accompanying software (the “Course Book Buyback Application”) for transacting sales between Course Book Sellers and Course Book Buyers. There exists several embodiments of the present disclosure, including 1) an embodiment for transacting sales between general Course Book Sellers and Course Book Buyers, where the Course Book Seller operates the Course Book Buyback Application; 2) an embodiment for transacting sales between general Course Book Sellers and Course Book Buyers, where a third party operates the Course Book Buyback Application; 3) an embodiment for transacting sales between Student Sellers and Buyers, where the Student Seller operates the Application; and 4) an embodiment for transacting sales between Student Sellers and Buyers, where a third party operates the Application.

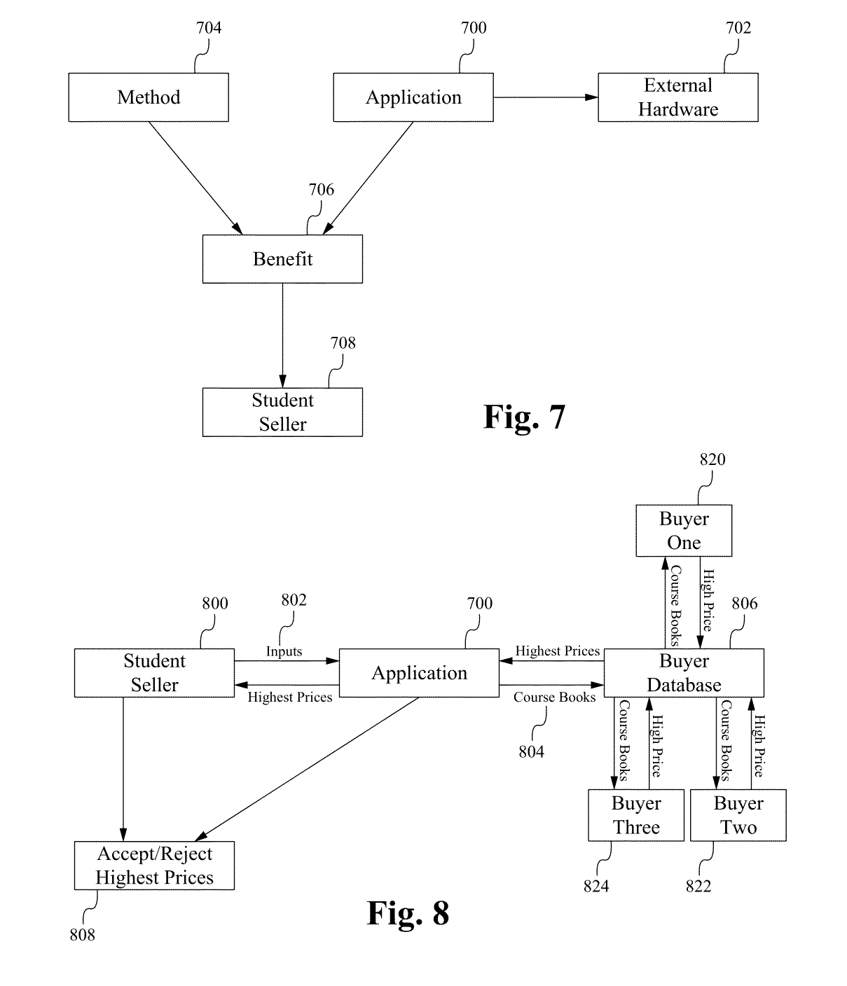

FIG. 7 illustrates an embodiment of the transactions methods with component parts, the Course Book Buyback Application and the Course Book Buyback Method. The Course Book Buyback Application 700 operates on an external hardware system 702. The Application 700 implements tasks set forth by the Course Book Buyback Method 704, and in conjunction with one another, the Course Book Buyback Application 700 and the Course Book Buyback Method 704 confer the Course Book Buyback Benefit 706 onto the Student Course Book Seller 708. The Course Book Buyback Benefit 706 includes the information provided to Student Course Book Sellers 708 (or general Course Book Sellers in other embodiments of the transaction methods) allowing them to maximize Course Book sales revenue while simultaneously avoiding the high time costs associated with completing the Course Book Buyback Process.

An embodiment of the transactions methods' Course Book Buyback Method, as an overall scheme, is illustrated by the diagram in FIG. 8. Implemented by the Course Book Buyback Application, the Course Book Buyback Method in this embodiment begins with the Student Course Book Seller 800 entering Course Book Buyback Inputs 802 into the Course Book Buyback Application 700. Course Book Buyback Inputs 802 includes any criteria a Course Book Seller 800 may use to search for a particular Course Book 804 online, including, but not limited to, Course Book titles, authors, and ISBN's, as well as the name of the educational instructor to assign the Course Book, the identification of the course for which the Course Book is assigned, and a list of courses in which the Course Book Seller 800 is or was enrolled. Each of these Course Book Buyback Inputs 802 corresponds to one or more Course Books the Student Course Book Seller wishes to sell to online Course Book Buyers. These Course Books are queried across a Course Book Buyer database 806. Three Course Book Buyers (820, 822, 824) are shown in this diagram, but the Course Book Buyback Method may query a database including an unlimited number of Course Book Buyers. Each Course Book Buyer queried then feeds back the highest price at which it will purchase each Course Book. The highest prices are displayed for viewing by the Student Course Book Seller, who either accepts or rejects each of them in turn 808.

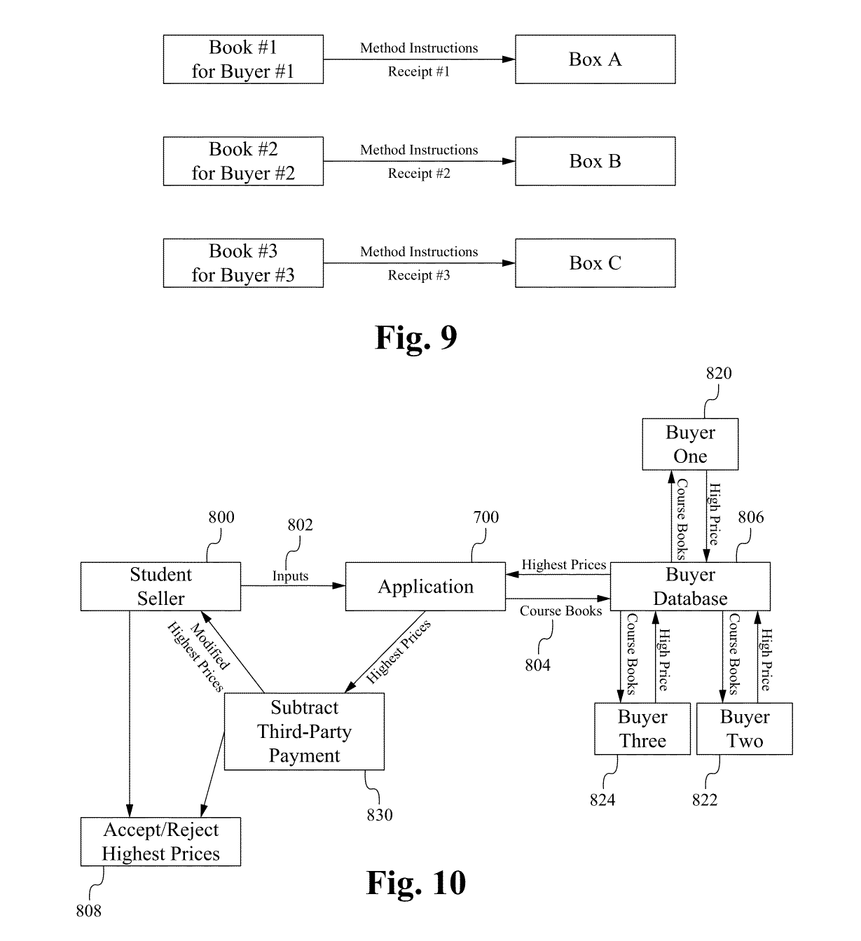

Should the Student Course Book Seller accept the listed prices, the Course Book Buyback Method, via the Course Book Buyback Application, instructs the Student Course Book Seller or third-party operator of the software specifically how to organize the Course Books sold and completes the Course Book Buyback Process in full. An embodiment of the present disclosure in FIG. 9 illustrates how the Course Book Buyback Method accomplishes this. The Student Course Book Seller in FIG. 9 has sold three books, Book#1, Book#2, and Book#3, to Buyer#1, Buyer #2, and Buyer#3, respectively. The Course Book Buyback Method instructs the Student Course Book Seller to place Book#1 in Box A, Book#2 in Box B and Book #3 in Box C. It also instructs the Student Course Book Seller to place Receipt #1 in Box A, Receipt #2 in Box B, and Receipt #3 in Box C. While FIG. 9 displays the Course Book Buyback Method with three books only, the Course Book Buyback Method and the Course Book Buyback Application are able to apply a similar procedure for an unlimited number of books.

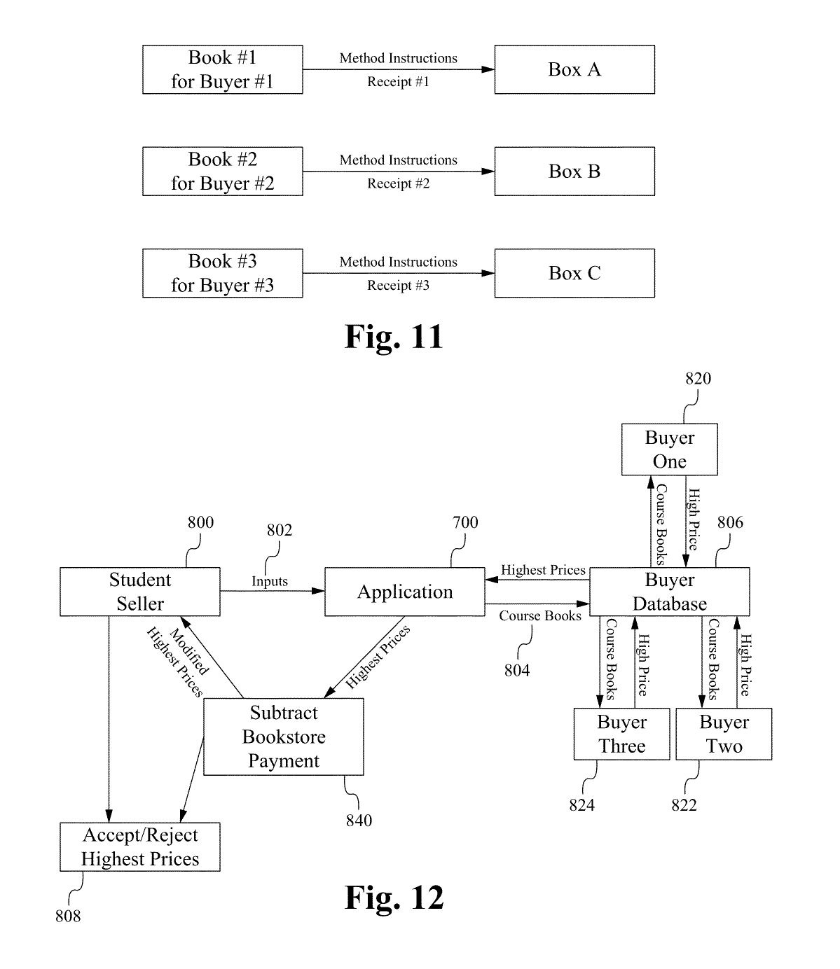

FIGS. 10 and 11 diagram another embodiment of the transactions methods. The embodiment in FIGS. 10 and 11 is substantially similar to the embodiment illustrated in FIGS. 8 and 9, but in FIGS. 10 and 11, a third party, rather than a Student Course Book Seller, is operating the Course Book Buyback Application to implement the Course Book Buyback Method. This adds a step to the Course Book Buyback Method, as is illustrated in the center portion of FIG. 10: the Course Book Buyback Method subtracts a payment for the third party operator 830, be it a direct payment, a commission payment, or a combination of both, and calculates this payment into the highest prices displayed for the Student Course Book Seller, as is illustrated by FIG. 10. FIG. 11 is identical to FIG. 9, except now a third party, as opposed to a Student Course Book Seller, is completing the Course Book Buyback Process in accordance with the Course Book Buyback Method's instructions.

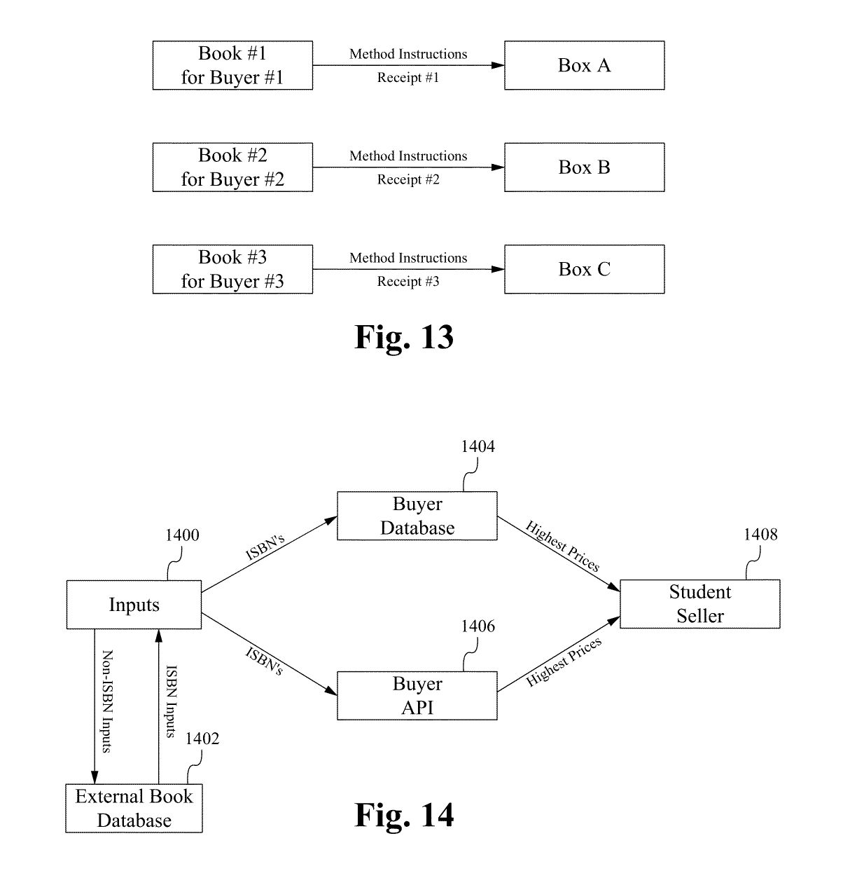

The embodiment diagramed in FIGS. 12 and 13 represents a special case of a third party operator. This is the case of the on-campus provider of Course Books (the “Bookstore”). Like all other third party operators, the Bookstore or its agents complete the Course Book Buyback Process in accordance with the Course Book Buyback Method's instructions, and the Course Book Buyback Application subtracts commission payments for the Bookstore 840 when it calculates the highest Course Book prices for display to the Student Course Book Seller. Though not diagramed, examples of embodiments with other third party operators for Student Course Book Sellers include embodiments where the third party operators include student-run clubs and organizations, student governments, and entities controlled by the local educational institute itself.

Other embodiments of the Method, though not illustrated in the diagrams, are identical to the embodiments displayed in FIGS. 7 through 11, except that the Student Course Book Seller is, in all cases, replaced by a general Course Book Seller.

The Course Book Buyback Application component of the transactions methods implements the Course Book Buyback Method component. FIG. 14 diagrams an embodiment of the Course Book Buyback Application component. The Course Book Buyback Application begins through receiving Course Book Buyback Inputs 1400. If the Course Book Buyback Input 1400 is not in ISBN format, the Course Book Buyback Application accesses an external book database 1402, located at the bottom left of FIG. 14, and from there acquires corresponding ISBN's to assign to each Input. The Course Book Buyback Application then uses individual Course Book ISBN's to request Course Book prices from a Course Book Buyer database 1404 or from application programming interfaces (API's) 1406 provided by the Course Book Buyers. The Course Book Application selects the highest of these prices and feeds it back to the Student Course Book Seller 1408, who accepts or rejects the offer.

The Course Book Buyback Application then requests and obtains necessary data from the Course Book Buyer database or from the Course Book Buyer-specific API's such that the Course Book Buyback Method is able to instruct the Student Course Book Seller how to complete the Course Book Buyback Process. The Course Book Buyback Method's instructions, using the data provided to it by the Course Book Buyback Application, are illustrated by the embodiments diagramed in FIG. 9, FIG. 11, and FIG. 13.

The Course Book Buyback Application's embodiment, as diagramed in the Figures, is encoded using any imperative programming language that is able to be compiled onto any hardware platform.

The Course Book Buyback Method, via the Course Book Buyback Application, is able to operate across different external hardware platforms. The transactions methods operate across any external hardware platform. The transactions methods are able to operate with an Android™ system, an Apple® system, a Windows® system and/or any other system. A Course Book Seller using an android or similar hardware device has the option of scanning or typing the Course Book Buyback Inputs into the Course Book Buyback Application for processing. The transactions methods able to operate on a personal computer, smart phone or any other device. A Seller using a personal computer will more likely type in than scan the Course Book Buyback Inputs into the Course Book Buyback Application. These implementations are possible, but not exclusive, manifestations of the embodiment operating on external hardware platforms.

The present disclosure encompasses a method (the “Buyback Method” or “Method”) and accompanying application (the “Buyback Application” or “Application”) for transacting sales between Sellers and Buyers for Products that are able to be identified with Numbers. There exists several embodiments of the transactions methods, including 1) an embodiment for transacting sales between general Sellers and Buyers, where the Seller operates the Application; 2) an embodiment for transacting sales between general Sellers and Buyers, where a third party operates the Application; 3) an embodiment for transacting sales between Student Sellers and Buyers, where the Student Seller operates the Application; and 4) an embodiment for transacting sales between Student Sellers and Buyers, where a third party operates the Application.

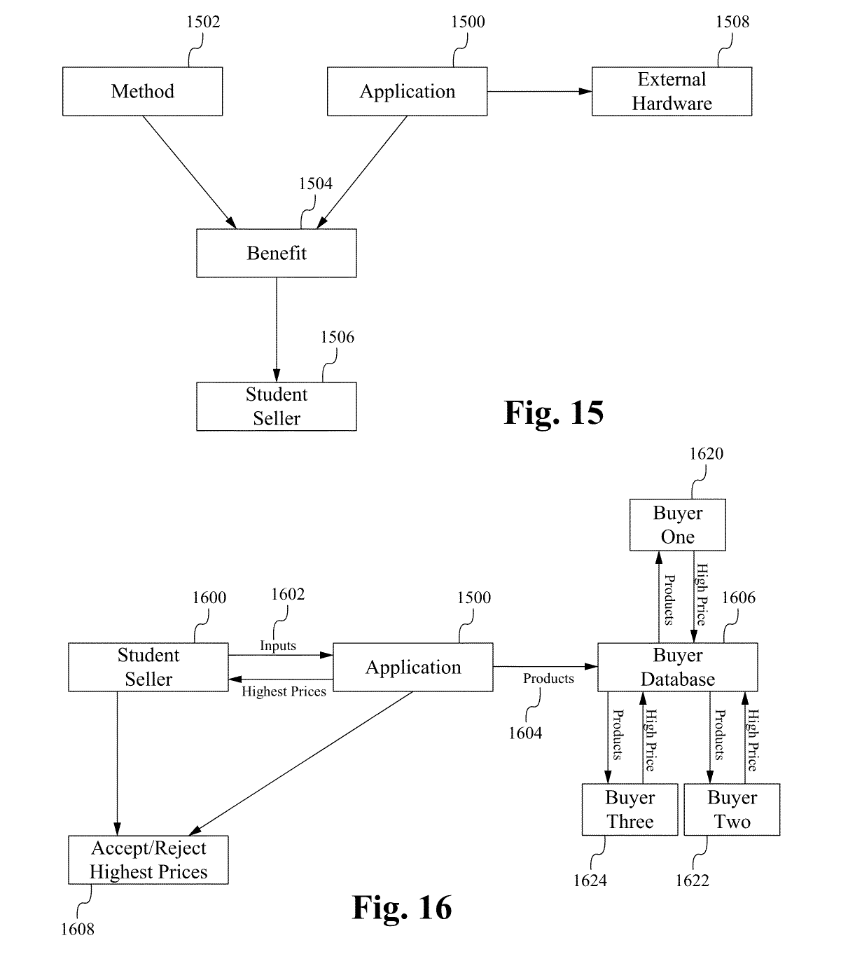

FIG. 15 illustrates an embodiment of the present disclosure with its component parts, the Buyback Application and the Buyback Method. The Application 1500 operates on an external hardware system 1508. The Application 1500 implements tasks set forth by the Method 1502, and in conjunction with one another, the Application 1500 and Method 1502 confer the Benefit 1504 onto the Student Seller 1506. The Benefit 1504 includes the information provided to Student Sellers 1506 (or general Sellers in other embodiments of the present disclosure) allowing them to maximize Product sales revenue while simultaneously avoiding the high time costs associated with completing the Process.

An embodiment of the transaction methods' Method, as an overall scheme, is illustrated by the diagram in FIG. 16. Implemented by the Application, the Method in this embodiment begins with the Student Seller 1600 entering Product Inputs 1602 into the Application 1500. Product Inputs 1602 includes any criteria a Seller 1600 may use to search for a particular Product 1604 online. Each of these Product Inputs 1602 corresponds to one or more Products 1604 the Student Seller 1600 wishes to sell to online Buyers. These Product Inputs 1602 are queried across a Buyer database 1606, displayed alongside the right side of FIG. 16. Three Buyers (1620, 1622, 1624) are shown in this Diagram, but the Method may query a database including an unlimited Number of Buyers. Each Buyer queried then feeds back the highest price at which it will purchase each Product. The highest prices are displayed for viewing by the Student Seller, who either accepts or rejects 1608 each of them in turn.

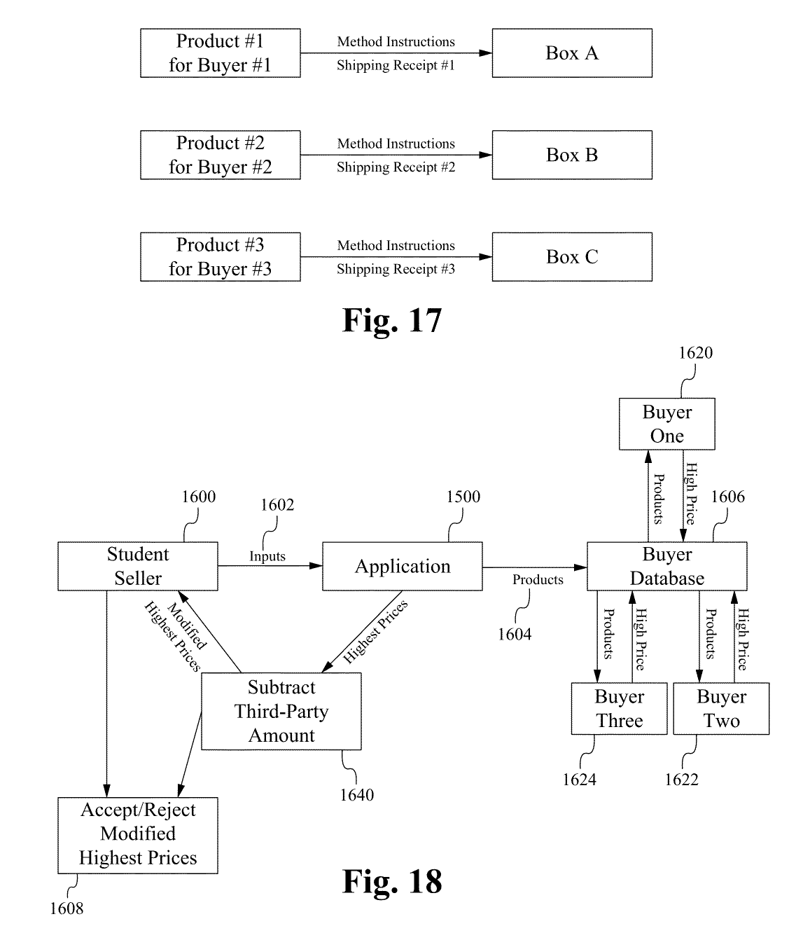

Should the Student Seller accept the listed prices, the Method, via the Application, instructs the Student Seller or third-party operator of the Application specifically how to organize the Products sold and completes the Process in full. An embodiment of the transaction method in FIG. 17 illustrates how the Method accomplishes this. The Student Seller in this diagram has sold three Products, Product#1, Product#2, and Product#3, to Buyer#1, Buyer #2, and Buyer#3, respectively. The Method instructs the Student Seller or Application operator to place Book#1 in Box A, Book#2 in Box B and Book #3 in Box C. It also instructs the Student Seller to place Receipt #¹ in Box A, Receipt #2 in Box B, and Receipt #3 in Box C. While FIG. 17 displays the Method with three Products only, the Method and the Application are able to apply a similar procedure for an unlimited Number of Products.

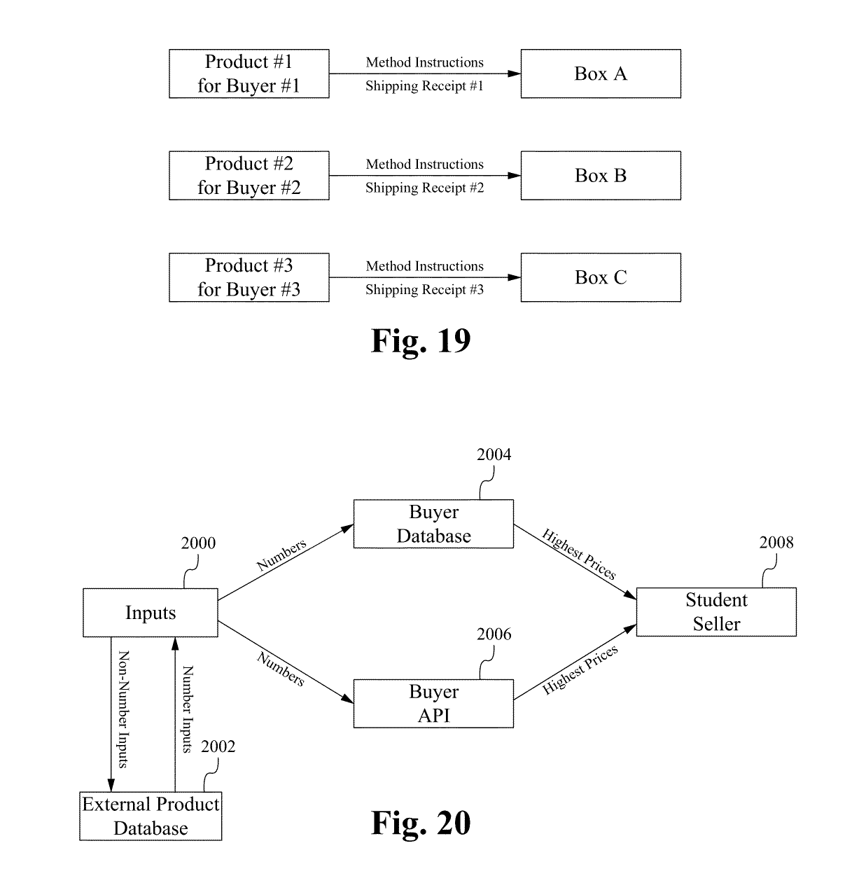

FIGS. 18 and 19 diagram another embodiment of the present disclosure. The embodiment in these diagrams is substantially similar to the embodiment illustrated in FIGS. 16 and 17, but in FIGS. 18 and 19, a third party, rather than a Student Seller, is operating the Application to implement the Method. This adds a step to the Method, as is illustrated in the center portion of FIG. 18: the Method subtracts a payment for the third party operator 1630, be it a direct payment, a commission payment, or a combination of both, and calculates this payment into the highest prices displayed for the Student Seller, as is illustrated by the left-most box in FIG. 18.

FIG. 19 is identical to FIG. 17, except now a third party, as opposed to a Student Seller, is completing the Process in accordance with the Method's instructions.

Other embodiments of the Method, though not illustrated in the diagrams, are identical to the embodiments displayed in FIGS. 15 through 19 except that the Student Seller is, in all cases, replaced by a general Seller.

The Application component of the transactions methods implements the Method component. FIG. 20 diagrams an embodiment of the Application component. The Application begins through receiving Product Inputs 2000. If the Input 2000 is not in Number format, the Application accesses an external Product database 2002, and from there acquires corresponding Numbers to assign to each Input 2000. The Application then uses individual Product Numbers to request Product prices from a Buyer database 2004 or from application programming interfaces (API's) 2006 provided by the Buyers. The Application selects the highest of these prices and feeds it back to the Student Seller 2008, who accepts or rejects the offer.

The Application then requests and obtains necessary data from the Buyer database or from the Buyer-specific API's such that the Method is able to instruct the Student Seller how to complete the Process. The Method's instructions, using the data provided to it by the Application, are illustrated by the embodiments diagramed in FIGS. 17 and 19.

The Application's embodiment, as diagramed in the Figures, is encoded using any imperative programming language that is able to be compiled onto any hardware platform.

The Application is able to operate across different external hardware platforms. The transactions methods operate across any external hardware platform. The transactions methods are able to operate with an Android™ system, an Apple® system, a Windows® system and/or any other system. The transactions methods are able to operate on a personal computer, a smart phone or any other device. A Seller using a personal computer will more likely type in than scan the Product Inputs into the Application. These implementations are possible, but not exclusive, manifestations of the embodiment operating on external hardware platforms.

In one embodiment, course, book and product data is collected by a variety of processes discloses and discussed above. However, collecting course, book and product data is not limited to the above disclosed methods. In one embodiment, a book or product by course search functionality is also provided, and may be any of the methods or processes discussed above, but it is not limited to the ones discussed above. In one embodiment, a buyback system is also provided that enables users to buyback books or other products that have been purchased previously. The buyback system may be similar to the methods described but is not limited to the buyback system discussed.

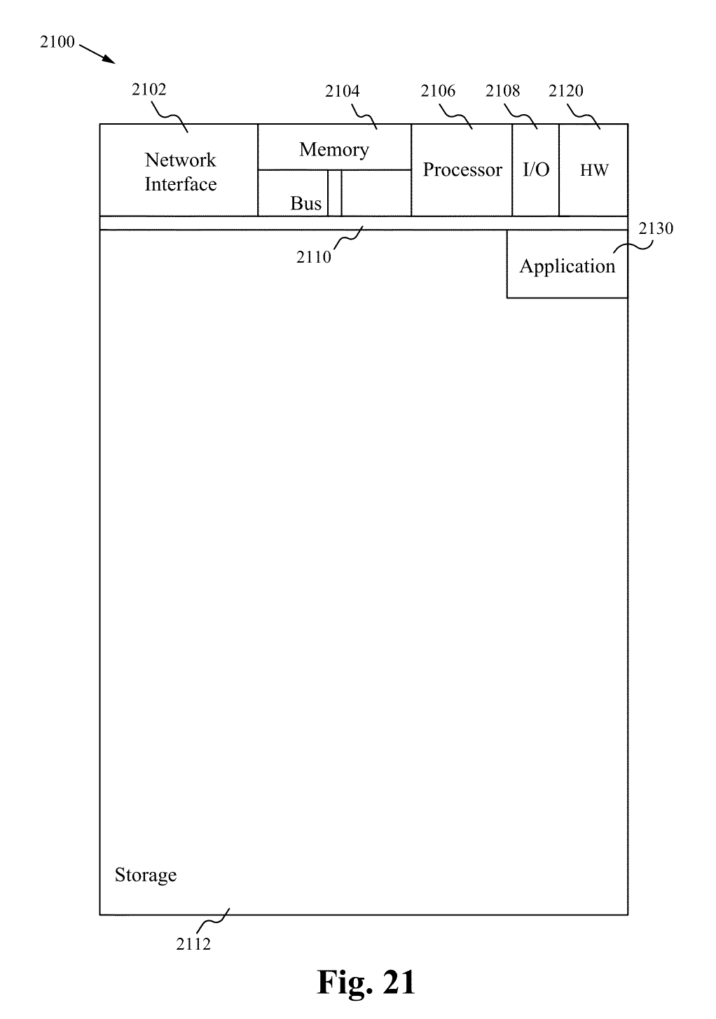

FIG. 21 illustrates a block diagram of an exemplary computing device configured to implement the methods according to some embodiments. The computing device 2100 is able to be used to receive, send, compute, process, communicate and/or display information such as comparative book purchase/rental prices, inventory lists, purchase/rental information, sales information, and/or any other relevant information. In general, a hardware structure suitable for implementing the computing device 2100 includes a network interface 2102, a memory 2104, a processor 2106, I/O device(s) 2108, a bus 2110 and a storage device 2112. The choice of processor is not critical as long as a suitable processor with sufficient speed is chosen. The memory 2104 is able to be any conventional computer memory known in the art. The storage device 2112 is able to include a hard drive, CDROM, CDRW, DVD, DVDRW, flash memory card or any other storage device. The computing device 2100 is able to include one or more network interfaces 2102. An example of a network interface includes a network card connected to an Ethernet or other type of LAN. The I/O device(s) 2108 are able to include one or more of the following: keyboard, mouse, monitor, display, printer, modem, touchscreen, button interface and other devices. In some embodiments, the hardware structure includes multiple processors and other hardware to perform parallel processing. Application(s) 2130 used to perform the methods are likely to be stored in the storage device 2112 and memory 2104 and processed as applications are typically processed. More or less components shown in FIG. 21 are able to be included in the computing device 2100. In some embodiments, hardware 2120 is included. Although the computing device 2100 in FIG. 21 includes applications 2130 and hardware 2120 for implementing the methods, the methods are able to be implemented on a computing device in hardware, firmware, software or any combination thereof. For example, in some embodiments, the applications 2130 are programmed in a memory and executed using a processor. In another example, in some embodiments, the hardware 2120 is programmed hardware logic including gates specifically designed to implement the method.

Examples of suitable computing devices include a personal computer, a laptop computer, a computer workstation, a server, a mainframe computer, a handheld computer, a personal digital assistant, a cellular/mobile telephone, a smart appliance, a smart phone, a tablet computer, a gaming console, a digital camera, a digital camcorder, a camera phone, a video player, a DVD writer/player, a Blu-ray® writer/player, a television, a home entertainment system or any other suitable computing device.

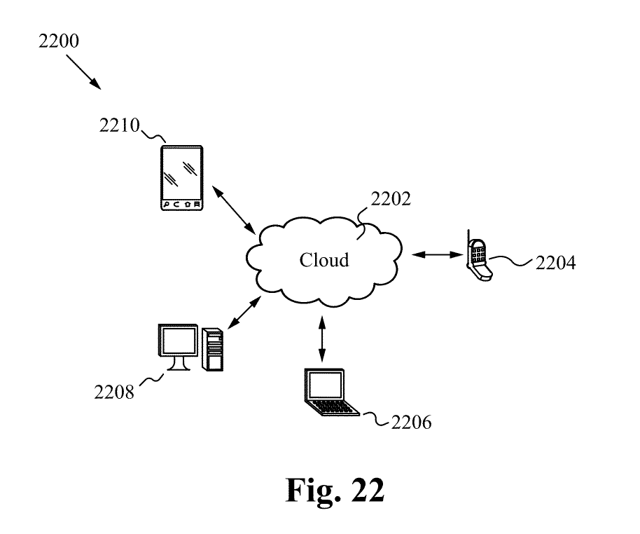

FIG. 22 illustrates a diagram of a network of devices utilizing cloud computing in accordance with an embodiment of the present disclosure. The price comparison methods and transactions methods are able to be implemented using cloud computing. The price comparison methods are able to receive course information as described herein, and compare specific information such as prices including bundled prices in the cloud, and then present the results of the comparison to users on their devices. The transactions methods are also able to be performed in the cloud by buyers and sellers submitting information to the cloud, the cloud performing the desired computations and presenting the results to the buyers and sellers.

A network of devices 2200 utilizes a cloud 2202 to perform computations, store data, compare data, send and retrieve data and communicate with user devices, so that the data processing occurs in the cloud and minimal processing occurs on the user device. User devices able to communicate with the cloud 2202 include, but are not limited to, a smart phone 2204, a laptop computer 2206, a desktop computer 2208, and a tablet computer 2210. For example, a user uses his smart phone to input his course schedule in an application which then communicates the information to the cloud which processes the course schedule to determine which books to buy, which books to bundle to offer the user the lowest total price for the bundle and where/how to buy the books.

To utilize the systems and methods described herein depends on the embodiment. In some embodiments, a system generates books to select from for purchase, and a user is able to select the books using a web browser or other input mechanism.

To utilize the systems and methods for facilitating transactions between sellers and buyers, the sellers input book/product information, and after the buyers are presented the book/product information, the sellers receive prices from buyers, from which they are able to accept or reject.

In operation, the systems and methods described herein facilitate acquisition of and generation of comparison information. The systems and methods use Course Books as intermediate outputs, a list of Course Book vendors and corresponding Criteria as final outputs, and Schedule Components, acquired online through the Web-Crawler Application, including multiple courses as inputs.

In operation, the systems and methods also assist with transactions between sellers and buyers.

Described herein are exemplary use scenarios. For example, a student selects courses. The system shows the user every book required for those courses. The student is able to see bundle prices from various retailers and is able to purchase all the books simultaneously with one click. Each bundle price is the price to buy all books simultaneously from a merchant of choice (e.g., Amazon.com, Half.com, Barnes & Noble, or others). The bundle prices are able to be modified with user preferences (e.g., seller rating, estimated shipping time, book conditions and/or others). The student then uses a one-click system to purchase a bundle option and pays the seller for desired books. In another example, the student pays a third-party for the books instead of the seller from which they are buying. The third-party then simultaneously places the order from the merchant of choice. In another example, the bundle price is from a combination of retailers, such as the bundle price includes two books from Amazon.com, three books from Half.com and five books from elsewhere to purchase a bundle of ten books. In yet another example, the student enters his/her student ID and the system automatically generates a course/book list. In these examples, elements from each example are usable with other elements from the other examples. In these examples, the course book requirements are provided through the school and not through a web crawler.

In the Figures, arrows represent software actions.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, units, blocks, modules, and steps have been described above generally in terms of their functionality. Whether such functionality is implemented as hardware or software depends upon the particular system and design constraints imposed on the overall system. Skilled persons can implement the described functionality in varying ways for each particular system, but such implementation decisions should not be interpreted as causing a departure from the scope of the present disclosure. In addition, the grouping of functions within a unit, module, block or step is for ease of description. Specific functions or steps can be moved from one unit, module or block without departing from the present disclosure.

The various illustrative logical blocks, units, steps and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module (or unit) executed by a processor, or in a combination of the two. A software module can reside in RAM memory, flash memory, ROM memory, EPROM memory, EEPROM memory, registers, hard disk, a removable disk, a CD-ROM, or any other form of machine or computer readable storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the present disclosure. Various modifications to these embodiments will be readily apparent to those skilled in the art, and the generic principles described herein can be applied to other embodiments without departing from the spirit or scope of the present disclosure. Thus, it is to be understood that the description and drawings presented herein represent a presently preferred embodiment of the present disclosure and are therefore representative of the subject matter, which is broadly contemplated by the present disclosure. It is further understood that the scope of the present disclosure fully encompasses other embodiments that may become obvious to those skilled in the art.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of generating price comparison information for books for multi-course student schedules programmed in a memory of a device comprising:
a. acquiring schedule components information;
b. generating intermediate outputs using the schedule components; and
c. generating final outputs using the intermediate outputs.

2. The method of claim 1 wherein acquiring the schedule components information is by schools submitting the schedule components information.

3. The method of claim 1 wherein acquiring the schedule components information is by a web-crawler.

4. The method of claim 3 wherein the web-crawler generates queues that determine from which school and education-related websites to acquire the schedule components information.

5. The method of claim 4 wherein the queues are distributed over a plurality of servers and external hardware devices.

6. The method of claim 3 wherein the web-crawler assembles an organized database of schedule components information.

7. The method of claim 1 wherein the intermediate outputs comprise course book information.

8. The method of claim 7 wherein the course book information comprises images of course books.

9. The method of claim 1 wherein the final outputs comprise pricing information and vendor information.

10. The method of claim 1 wherein the schedule components information includes departments, course names and course sections.

11. The method of claim 1 wherein the final outputs include bundled selections of course materials and price comparisons of the bundled selections.

12. The method of claim 11 wherein the bundled selections are from a single merchant.

13. The method of claim 11 wherein the bundled selections include bundles from a plurality of merchants.

14. The method of claim 1 wherein the final outputs are filtered using user selections.

15. A method of generating price comparison information for books for multi-course student schedules programmed in a memory of a device comprising:
a. acquiring schedule components information;
b. acquiring an input from a user;
c. generating intermediate outputs using the schedule components; and
d. generating final outputs using the intermediate outputs.

16. The method of claim 15 wherein the input includes a plurality of course selections.

17. The method of claim 15 wherein the input includes a department and a course.

18. The method of claim 15 wherein the input includes a school, an academic department, a course and/or a course section.

19. The method of claim 15 wherein acquiring the schedule components information is by schools submitting the schedule components information.

20. The method of claim 15 wherein acquiring the schedule components information is by a web-crawler.

21. The method of claim 20 wherein the web-crawler generates queues that determine from which school and education-related websites to acquire the schedule components information.

22. The method of claim 21 wherein the queues are distributed over a plurality of servers and external hardware devices.

23. The method of claim 20 wherein the web-crawler assembles an organized database of schedule components information.

24. The method of claim 15 wherein the intermediate outputs comprise course book information.

25. The method of claim 24 wherein the course book information comprises images of course books.

26. The method of claim 15 wherein the final outputs comprise pricing information and vendor information.

27. The method of claim 15 wherein the schedule components information includes departments, course names and course sections.

28. The method of claim 15 wherein the final outputs include bundled selections of course materials and price comparisons of the bundled selections.

29. The method of claim 28 wherein the bundled selections are from a single merchant.

30. The method of claim 28 wherein the bundled selections include bundles from a plurality of merchants.

31. The method of claim 15 wherein the final outputs are filtered using user selections.

32. A device comprising:
a. a memory for storing an application, the application programmed to perform the steps:
i. acquiring schedule components information;
ii. generating intermediate outputs including course book information using the schedule components; and
iii. generating final outputs including bundled selections of course materials and price comparisons of the bundled selections using the intermediate outputs; and
b. a processor for processing the application.

33. The device of claim 32 wherein acquiring the schedule components information is by schools submitting the schedule components information.

34. The device of claim 32 wherein acquiring the schedule components information is by a web-crawler.

35. The device of claim 34 wherein the web-crawler generates queues that determine from which school and education-related websites to acquire the schedule components information.

36. The device of claim 35 wherein the queues are distributed over a plurality of servers and external hardware devices.

37. The device of claim 34 wherein the web-crawler assembles an organized database of schedule components information.

38. The device of claim 32 wherein the course book information comprises images of course books.

39. The device of claim 32 wherein the final outputs comprise pricing information and vendor information.

40. The device of claim 32 wherein the schedule components information includes departments, course names and course sections.

41. The device of claim 32 wherein the bundled selections are from a single merchant.

42. The device of claim 32 wherein the bundled selections include bundles from a plurality of merchants.

43. The device of claim 32 wherein the final outputs are filtered using user selections.

44. A method of generating price comparison information for books for multi-course student schedules programmed in a plurality of cloud devices comprising:
a. acquiring schedule components information;
b. generating intermediate outputs using the schedule components; and
c. generating final outputs using the intermediate outputs, wherein the final outputs include bundled selections of course materials and price comparisons of the bundled selections.

45. The method of claim 44 wherein acquiring the schedule components information is by schools submitting the schedule components information.

46. The method of claim 44 wherein acquiring the schedule components information is by a web-crawler.

47. The method of claim 46 wherein the web-crawler generates queues that determine from which school and education-related websites to acquire the schedule components information.

48. The method of claim 47 wherein the queues are distributed over a plurality of servers and external hardware devices.

49. The method of claim 46 wherein the web-crawler assembles an organized database of schedule components information.

50. The method of claim 44 wherein the intermediate outputs comprise course book information.

51. The method of claim 50 wherein the course book information comprises images of course books.

52. The method of claim 44 wherein the final outputs comprise pricing information and vendor information.

53. The method of claim 44 wherein the schedule components information includes departments, course names and course sections.

54. The method of claim 44 wherein the bundled selections are from a single merchant.

55. The method of claim 44 wherein the bundled selections include bundles from a plurality of merchants.

56. The method of claim 44 wherein the final outputs are filtered using user selections.

57. A device for receiving price comparison information for books for multi-course student schedules comprising:
a. a memory for storing an application, the application programmed to perform the steps:
i. sending schedule information to a cloud system; and
ii. receiving final outputs including bundled selections of course materials and price comparisons of the bundled selections generated in the cloud system using intermediate outputs generated using the schedule information; and
b. a processor for processing the application.
